(19) United States
(12) Patent Application Publication
(10) Pub. No.: US 2014/0052464 A1
(43) Pub. Date: Feb. 20, 2014

(54) METHOD AND SYSTEM FOR REMOTE PATIENT MONITORING

(71) Applicant: Abhijit Ray, Kansas City, MO (US)

(72) Inventor: Abhijit Ray, Kansas City, MO (US)

(21) Appl. No.: 13/969,245

(22) Filed: Aug. 16, 2013

Related U.S. Application Data
(60) Provisional application No. 61/683,962, filed on Aug. 16, 2012.

(51) Int. Cl. G06F 19/00

(52) U.S. Cl. CPC G06F 19/3418
USPC 705/2

(57) ABSTRACT

A system for remotely monitoring a patient, the system comprises a plurality of input sources operable to acquire information corresponding to a well-being condition of a patient, an external database for storing analytical models and medical data, and a central controller being operable to receive the signal from the input sources, perform an algorithm to select an analytical model from the database based on the information and the data, perform an algorithm on the information and the data with the model to determine a state of the patient and formulate a health prediction, determine a recommendation as a result of the state and the health prediction, and transmit the recommendation to at least one external entity for providing support and assistance to the patient or to a caregiver of the patient.

### BACKGROUND

1. Field

Embodiments of the present invention relate to systems and methods for remotely monitoring a patient.

2. Related Art

Remote patient monitoring enables patients to live more independently and have access to medical assistance and care networks without living in assisted living facilities or hospitals. Systems and methods for remote patient monitoring detect events or conditions of patients and dispatch or recommend medical assistance. These systems include devices kept in the patients' homes or on their persons to detect the conditions or communicate with emergency personnel, medical providers, etc. However, known systems and methods are dedicated to only one aspect of the patient's health or well-being. Existing systems can be generally divided into several independent categories, such as Personal Emergency Response (PERS), Telecare, Activities of Daily Living Monitoring (ADL), Telehealth, Telemedicine, and Personal Health Records. These systems operate in isolation of each other, and thus, do not provide data to the other systems and do not work in conjunction with each other to provide more complete, more accurate, and more comprehensive monitoring and support to the patient.

### SUMMARY

Embodiments of the present invention solve the above-mentioned problems and provide a distinct advance in the art of remote patient monitoring.

One embodiment of the invention is a system for remotely monitoring a patient including a plurality of input sources such as a fall detector, a distress pendant, or other similar device for sensing a condition (or other information) related to the well-being of the patient, and a central controller for receiving a signal representative of the information, receiving medical analytical data or models, determining a recommendation for action or service by performing an algorithm on the information and the data, and transmitting the recommendation to an external entity for dispatching medical assistance, providing medical care or treatment, recordkeeping, or further processing. The controller includes a processor for performing the algorithm, and at least one communication port, such as a mobile device docking station or a wireless transmitter, for communicating with the input sources, the database, and the external entity.

Another embodiment of the invention is a method for remotely monitoring a patient comprising the steps of collecting information about a patient including information corresponding to a well-being condition of a patient, medical records, health information, etc., retrieving medical analytical data or models, determining a recommendation for an action or service by performing an algorithm on the information, the data, and the models, and transmitting a signal representative of the recommendation to the external entity and/or the database for dispatching medical assistance, providing medical care or treatment, recordkeeping, or further processing.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a schematic plan view of a system for remotely monitoring a patient, in accordance with an embodiment of the invention;

FIG. 2 is a flow chart of a method for remotely monitoring a patient, in accordance with an embodiment of the invention;

FIG. 3 is a screen capture of a graphical display of a patient's medical overview, in accordance with an embodiment of the invention;

FIG. 4 is a screen capture of a graphical display of a patient's medical state, in accordance with an embodiment of the invention; and

FIG. 5 is a screen capture of a graphical display of a spreadsheet of patient information, in accordance with an embodiment of the invention.

The drawing figures do not limit the current invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the current invention. The following detailed description is, therefore, not to be taken in a limiting sense. The scope of the current invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

The present invention provides a system 10 and a method 12 that provide an integrated approach to collecting, analyzing, and delivering health data and providing health assistance and services to a patient. The present invention collects specific real-time data needed for making a recommendation pertaining to the patient's well-being. For example, a blood pressure and a heart rate of the patient and a temperature and a humidity measurement of the patient's room can be collected. The system analyzes the information and provides a medical recommendation as a result thereof. This allows caregivers and clinicians to respond timely to changes in health conditions, thereby enabling them to intervene and remotely provide or modify treatment for the patient as needed. The system 10 and the method 12 adhere to requirements for patient safety and confidentiality.

In embodiments of the invention, computing devices and/or databases may implement a computer program and/or code segments of the computer program to perform some of the functions described herein. The computer program may comprise a listing of executable instructions for implementing logical functions in the user device. The computer program can be embodied in any computer readable medium for use by or in connection with an instruction execution system, apparatus, or device, and execute the instructions. In the context of this application, a “computer readable medium” can be any means that can contain, store, communicate, propagate, or transport the program for use by or in connection with the instruction execution system, apparatus, or device. The computer readable medium can be, for example, but not limited to, an electronic, magnetic, optical, electro magnetic, infrared, or semi conductor system, apparatus, device or propagation medium. More specific, although not inclusive, examples of the computer readable medium would include the following: a portable computer diskette, a random access memory (RAM), a read only memory (ROM), an erasable, programmable, read only memory (EPROM or flash memory), and a portable compact disk read only memory (CDROM), and combinations thereof. The various actions and calculations described herein as being performed by or using the computer program may actually be performed by one or more computers, processors, or other computational devices, such as the controller described herein, independently or cooperatively executing portions of the computer program.

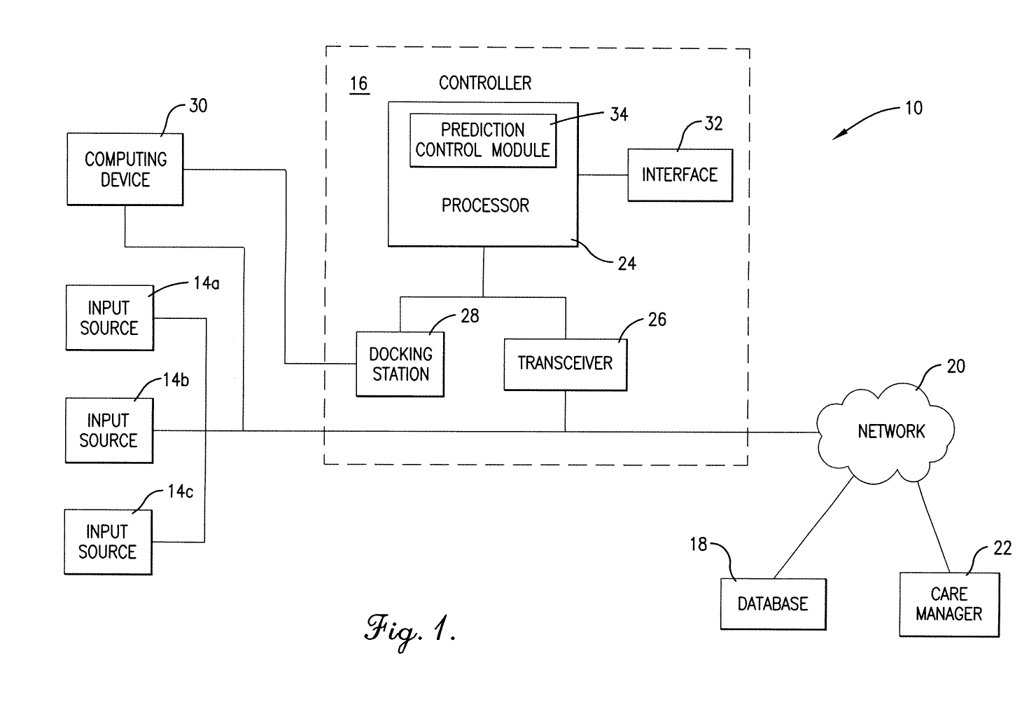

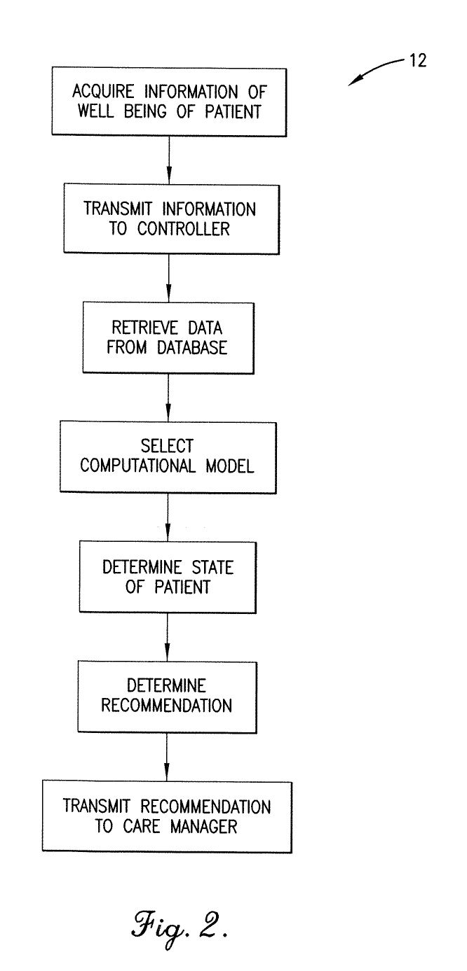

Turning to the figures, and particularly FIGS. 1 and 2, the system 10 remotely monitors a patient and comprises a plurality of input sources 14a-c and a central controller 16 communicatively coupled to the input sources 14a-c. In this description, the term “patient” may mean an outpatient, a chronic care patient, an infant or child, a geriatric person, or any other person with a need for even a modicum of medical care or living assistance. The input sources 14a-c acquire information relating to a patient's well-being and transmit a signal representative of the information to the controller 16. The controller 16 is communicatively coupled to the input sources 14a-c and to an external database 18 and other resources over a network 20 and performs an algorithm on information, data, and models received therefrom for formulating a health prediction, determining a state of the patient, and for determining a recommendation for health services, medical assistance, or other actions pertaining to the state of the patient. The controller 16 is also operable to communicate with an external entity 22 over the network 20 for transmitting the recommendation thereto and for providing communication between the external entity 22 and the patient or a caregiver.

The plurality of input sources 14a-c acquires information relating to a patient's well-being by sensing or detecting the information via one or more sensors, or when the patient activates the source via a button or by placing a telephone call, and transmits the signal to the controller 16. The signal may be transmitted wirelessly such as via Bluetooth, radio frequencies, or infrared technology, or via a telephone line. One or more of the plurality of input sources 14a-c may also be a database or other information source such as the Electronic Health Record (EHR) or the Health Information Exchange (HIE), or a unique genetic profile of the patient. As such, the input sources 14a-c may take many different forms.

The particular input sources 14a-c can be selected according to the patient's needs. Active sources monitor the patient's vital signs and other physiological data or send an alert when activated by the patient. Passive sources sense the patient's movement throughout his house or track other behaviors of the patient. Passive sources may perform an algorithm to determine that the patient requires assistance and automatically send an alert for help. The input sources 14a-c may use geolocation or real-time tracking techniques and may detect the location of the patient within 1 foot to 100 feet and may determine whether the patient is standing upright, laying on a bed or fallen on a bathroom floor, for example. The tracking techniques may require that an input source 14a-c is communicatively coupled to a global navigational satellite system (GNSS) or to positional sensors positioned around the patient's living area. The input sources 14a-c may be worn or carried by the patient or placed around the patient's living facility such as on walls, ceilings, floorboards, and furniture and may include position sensors, accelerometers, gyroscopes, thermometers, heart monitors, blood pressure meters, blood glucose meters, blood oxygen meters, blood coagulation meters, weight scales, or other devices. Exemplary input sources 14a-c include a chair sensor, a bed sensor, a door usage sensor, an electrical usage sensor, a closed-circuit television (CCTV) device, an intruder detector, a flood detector, a thermostat, a fall detector, an X10 automatic light, an epilepsy bed sensor, a wandering client alert, a strobe alert, a vibrating pillow alert, a distress pendant, a community alarm speech module, and an emergency pull cord. For example, the thermostat may be placed in the patient's bedroom and senses if the room temperature rises to a dangerous temperature. A transmitter coupled to the thermostat can transmit a signal representative of the high temperature to the controller 16. As another example, the distress pendant is worn by the patient and tracks the patient's location. If the patient falls or has a medical emergency, the patient can press a button on the pendant. The pendant generates a signal representing that the patient needs immediate assistance and representing the patient's location. The distress pendant may include a real-time location system to track the patient using wireless signals. The input sources 14a-c may be non-medical and may relate more generally to the patient's well-being, such as an intruder alert, which generates a signal indicating that an intruder has entered the patient's house or living space. As a further example, a database such as the ENR or HIE may determine that the patient is due for a checkup, a change in treatment, or other event and may communicate such information to the controller 16. The input sources 14a-c may be configured to “check in” with the controller 16 periodically or in response to a predetermined sensor reading. The information may also include a genetic profile, biomedical information, and patient administration data.

The signal transmitted by the input sources 14a-c may be initiated automatically in response to certain triggers such as a predetermined sensor reading or may by manually initiated by the patient, a caregiver, a clinician, or a third party. The signal is optionally packaged in an appropriate format for transmittal and may be retransmitted via Bluetooth, radio frequency, Internet, telephone, or short message service (SMS) text, to appropriate caregivers, health personnel, third parties, insurance companies, or the patient himself. The information represented by the signal may be recorded and stored for viewing, future analysis, data accumulation, and system diagnostics.

The central controller 16 is communicatively coupled to the input sources 14a-c, the external database 18, and the external entity 22 such as a health organization or a care manager. The controller 16 may be integral with one of the input sources 14a-c or vice versa. As such, the controller 16 may be a wearable pendant, a smart watch, a smart ring, a mobile device, a desktop or bedside unit, a computer, or any other device. The controller 16 may incorporate electronic miniaturization for being less cumbersome or inhibiting to the patient such as including micro or nano processors and nanocircuits. The controller 16 may include a processor 24 for manipulating the information represented by the signal received from the input sources 14a-c and other inputs. The controller may include or be other computing components, without limitation, as described above. The controller 16 also may include a transceiver 26 or other communication port for receiving the signal, a docking station 28 for connecting to a computing device 30, and an interface 32 for interacting with the patient, as described below. The controller 16 may make a periodic status query to the input sources 14a-c to verify that the input sources 14a-c are responsive and properly configured. The controller 16 is connected to the database 18 and the external entity 22 via the network 20, which may be via a wireless internet connection, Ethernet, a cellular network, a “landline”, or a similar network. The controller 16 (and its related components) is powered via a wall source or an internal power source.

The processor 24 retrieves data such as medical statistics and analytical models from the database 18 (described below) relating to the information of the input sources 14a-c. The data can be aggregated from disparate sources including an EHR or HIE (described above), genetic profiles, or from the input sources 14a-c to create a health profile for the patient. The processor 24 selects a model from the database 18 by performing a first algorithm on the information of the input sources 14a-c. For example, if particular medical research shows that a non-linear regression model is the most appropriate model for analyzing diabetes, then this model is used. On the other hand, if a neural network is the best model for predicting emergencies of patients with breast cancer, then the neural network model is used. Exemplary models include but are not limited to linear, non-linear, logistic regression probabilistic, neural networks, Bayesian inferences, clustering, fuzzy logic, and model based reasoning. Logistic regression models are used for predicting the probability of an event or state by fitting data to a “logit” function. For example, the probability that a patient has a heart attack within a specified time period might be predicted from knowledge of the patient's age, sex, and body mass index. This correlation is formed by utilizing univariable and multivariable logistic regression to identify those factors associated with the condition. Evaluation of predictors associated with the event is performed using matched analysis and identifying patient clusters. The algorithm may utilize case based reasoning which uses prior knowledge to solve problems, critique solutions, and explain anomalous situations. The algorithm may use propensity scoring which reduces sample bias and increases prediction precision for a given type of patient. A score generated by propensity scoring presents patients having similar characteristics such as age, comorbidity, or drug use. The score is calculated based on factors contributing to the patient's ailment or condition. As an example, the following are risk factors for cardiopulmonary morbidity: increased age, previous cardiac surgery, chronic obstructive pulmonary disease, use of muscle relaxants as part of general anesthesia, and major surgery. A sample matching the propensity score will be similar for any covariate that went into computing the propensity score.

The processor 24 then determines a state of the patient by performing a second algorithm on the information, the patient's health profile, and other data. The determined state may be a medical emergency such as a heart attack, a low sugar attack, a seizure, or date of a scheduled appointment, for example. The processor 24 may use natural language processing (NLP) for this analysis, as described below. The algorithm analyzes the information and the data within the framework of the model and any adjustments made thereto. The algorithm is context-aware and is capable of predicting outcomes based on real-time information from the input sources 14a-c, accumulated life-style information (such as meal preparation, bathroom usage, and sleep patterns), continuum of care (365 days) clinical data, and data from the external database 18 such as the Regional Health Information Organization. The processor 24 formulates a prediction based on the state or related outcomes or inferences as a result of the algorithm and generates one or more recommendations corresponding to the prediction. The recommendation may be in the form of an alert, or a request for an action to be performed. For example, the processor 24 may trigger a wandering patient alert or may predict that the patient is at an increased risk of diabetes and may communicate with the external entity 22 (described below) to schedule a medical appointment. The prediction may assist caregivers or doctors in making a health decision for the patient.

The processor 24 and/or programs implemented by the processor may include a prediction control module 34 that monitors results generated by the algorithms and makes any necessary adjustments to the model selection or to the results for optimizing sensitivity and specificity to the system 10. Sensitivity is the ability to correctly detect a symptom, while specificity relates to the ability to avoid mislabeling anything normal as a symptom. These two properties must be balanced. The prediction control module 34 may allow for an expert or other user to provide input after reviewing the results. This input may be stored in the database 18 for use in future analysis. The prediction control module 34 (or more generally, the processor 24) may also perform an algorithm to determine the reliability of the model. The prediction control module 34 or processor 24 may use reliability statistics to determine a “probability of accuracy”, i.e., the probability that a prediction will perform a required function under stated conditions for a specified period of time. Reliability statistics and reliability growth modeling may be used to measure the rate of an event's occurrence in a defined population. It is possible to model not only de facto “current” event rates, reliability levels, or safety levels, but also reliability growth. In this scenario, the processor 24 performs regressions on the data that have accrued to-date and extrapolates to what the quantitative reliability/safety level will be at a selected future time. The processor 24 may also calculate a statistical estimate of an achievable asymptotic plateau level as a time variable is advanced to infinity.

The radio frequency transceiver 26 transmits and receives signals representing information and data between the input sources 14a-c, the external database 18, or the external entity 22 and the controller 16. The transceiver 26 communicates the signals wirelessly through its antenna on predetermined radio frequencies. The transceiver 26 uses frequencies of between 30 kHz to 300 GHz. The signal may be represented as variations in the amplitude of the carrier wave.

The docking station 28 is configured to receive a computing device 30 such as a laptop, a tablet, a smartphone, a pager, or any other device. The computing device 30 provides processing power for performing some or all of the tasks described herein. The computing device 30 may also comprise the interface 32, described below, The computing device 30 may further include a transceiver for receiving or transmitting signals as described above, or an internet connection or other communication ports for communicating with the external entity 22 as described below.

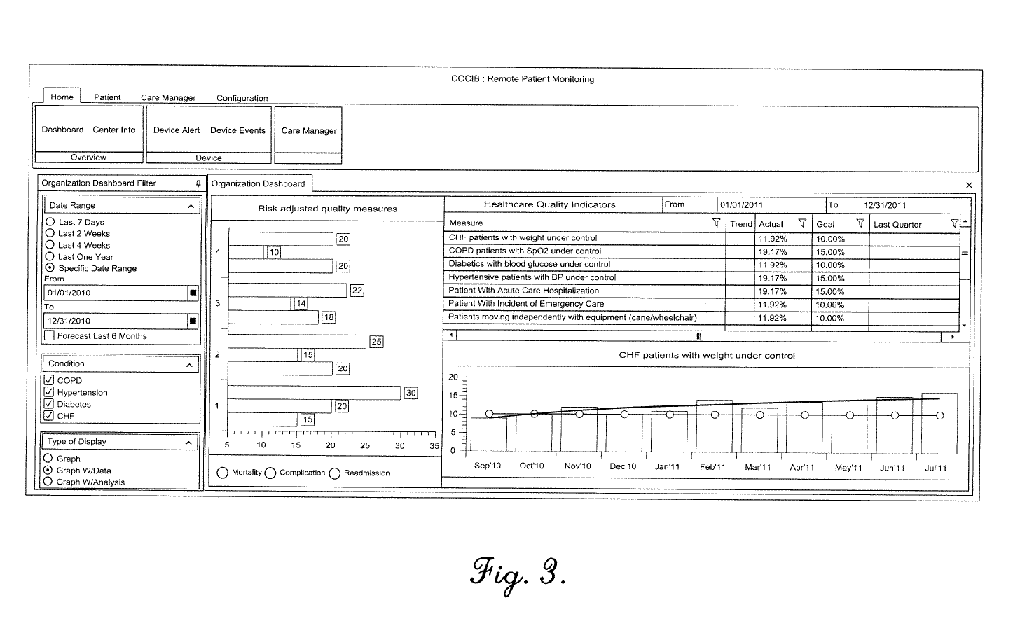

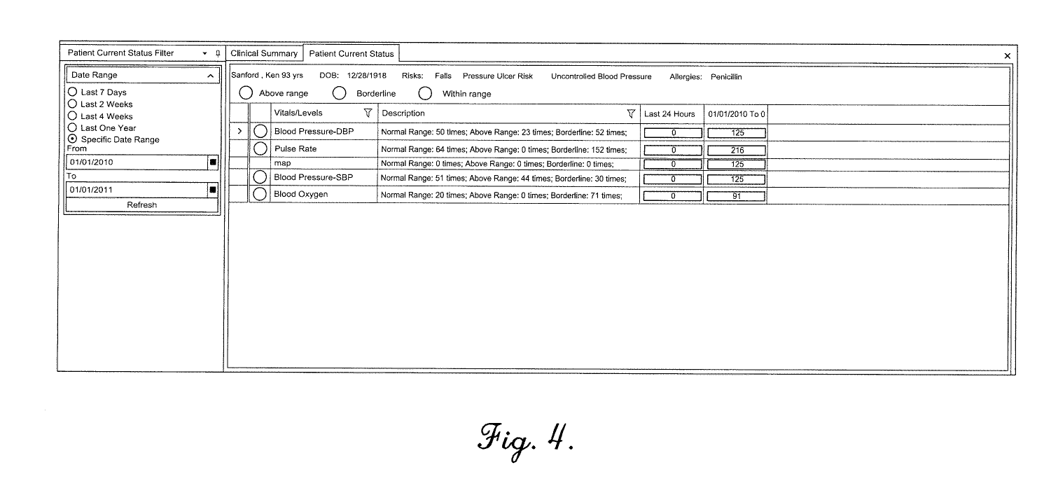

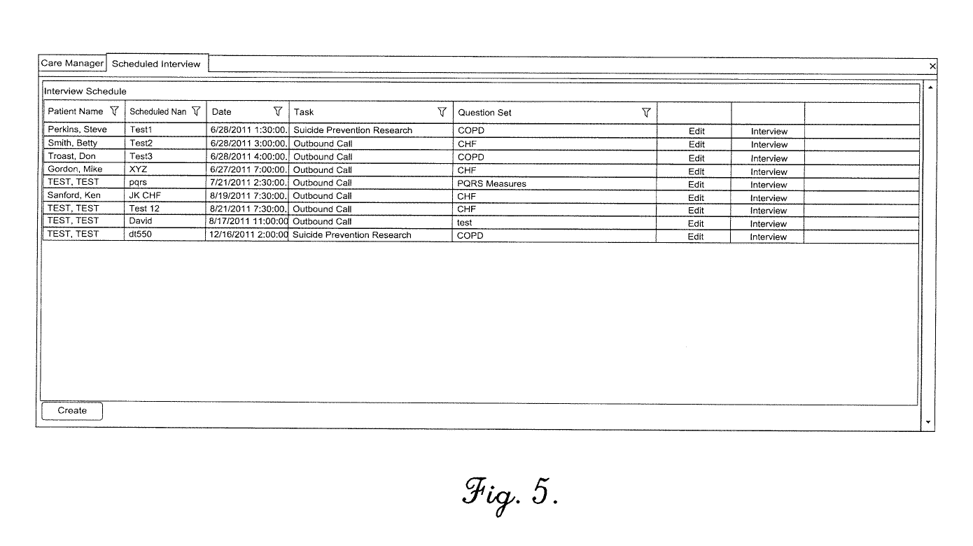

The interface 32 communicates the results to the patient or another user, displays notifications, provides additional visualizations, allows the patient to provide additional input for the processor 24 or prediction control module 34 to use in the algorithms, or allows the patient or a caregiver to communicate with the external entity 22 to receive instructions or medical care assistance. The interface 32 may include buttons, switches, dials, speakers, microphones, a webcam, a control pad, or a touchscreen for displaying virtual buttons, menus, windows, etc. The interface 32 displays results and other information in the form of reports, summaries, or graphs. The interface 32 also displays a current status, alerts, and other notifications. The interface 32 may provide any information, data, or analysis created by the system to the patient, another user, or a caregiver, in the form of a report (FIGS. 3-5). The report can be provided by request, automatically as it is created, or at predetermined intervals. The report may provide a complete synopsis of the patient's health as it relates to activities of daily life and specific health conditions. The interface 32 allows for the patient or a caregiver to document medical information such as allergies, vital measurements, medical conditions, medical tests, medications, and related data such as a recommended physician, a severity of a medical condition, the patient's state, and comments and notes. The report may provide a broad snapshot or overall view of the patient's health or daily ailments. The interface 32 may additionally include a decision support tool that utilizes the reports etc. to allow caregivers, healthcare providers, etc. (i.e., decision makers) to make well-informed decisions. The decision support tool provides both prospective and retrospective assistance in improving the quality of patient care. The decision support tool allows decision makers to see sub-par performances of the past as well as proposed changes and improvements. The interface 32 also provides for bidirectional communication between the patient the external entity 22.

The external database 18 stores comprehensive data of many patients and medical records, as well as medical models and trends. The database 18 may be remote from the controller 16, such as in a regional facility or may be integral to the controller 16. The database 18 provides a large amount of contextual clinical or life-style information (such as meal preparation, bathroom usage, or sleep patterns), which in turn allows the invention to provide a more informed recommendation. Contextual information may be garnered from people, environment, and activities. Any data that is used to identify an entity (i.e., a person, a place, or an object) in a context (a location and person's state, as described above) is stored or input into the models or trends. For example, a centralized contextual model allows for data sharing by devices, services, and agents within a specific context, acquiring contextual information from data sources, detecting and resolving inconsistent knowledge stored in a shared context, and protecting patient privacy by enforcing policies based on contextual rules. The database 18 collects time-stamped continuum of care clinical data generated by the system 10, which is ideally suited for time series analysis within or across health care encounters. The database also collects real-time data, which is suited for constructing a sequence of events during an encounter, linking previous encounters to obtain information about comorbid conditions and past treatments, and linking to subsequent encounters to obtain information about outcomes. The combination of time-stamped clinical data with diagnosis and procedure data can be used to distinguish between chronic conditions, acute and/or new onset conditions, and complications. Thus, the database 18 adapts to new inferences and conclusions, and creates new data relationships therebetween. For example, the database 18 may include a conclusion that there is a high probability for a diabetic patient to suffer a fall based on facts stored therein that people with diabetes have increased chances of suffering from vertigo. Because people suffering from vertigo frequently fall, the database 18 adapts to conclude that there is a relationship between diabetes and a probability of falling. The database 18 is configured to receive updates and additional information from external sources such as biomedical research and/or other reliable health information sources and from recommendations generated by the system 10.

In order to more efficiently facilitate generating and storing new conclusions and information, the database 18 may utilize Ontology based Knowledge Representation. Such a structure provides a formal computer-friendly meaning of concepts (e.g., organization of care, lifestyle and psychosocial factors, and payers, etc.). The external database 18 may use natural language processing (NLP) to recognize medical concepts and to automatically compose and decompose their semantic relationships. This feature provides a “structured intelligence” for determining how to store, recognize, retrieve, and interpret medical information and patient records. NLP may utilize ontology standards such as Resource Description Framework (RDF) or Web Ontology Language (OWL). These ontology standards solve data integration problems by interacting with other modular architectural components. Integration is accomplished by data creation, content and meta-data specification, and data access. For example, RDF supports ontology based data aggregation by providing a model for the data and syntax for independent parties to exchange and use the data.

The controller 16 is also configured to be communicatively coupled to (or in communication with) an appropriate external entity 22 such as a family member, a doctor, a nurse, a paramedic, a first responder, a system administrator, a care manager, or other healthcare provider, for transmitting the recommendation thereto. For example, if the recommendation is for immediate medical attention, the controller 16 contacts the nearest hospital and requests an ambulance be sent to the patient's location. As another example, if the recommendation is for a precautionary checkup, the controller 16 contacts the patient's doctor and healthcare provider and requests an appointment. The external entity 22 interprets the recommendation and provides an appropriate action in an efficient and timely manner, such as dispatching the ambulance or scheduling the appointment.

Turning now to FIG. 2, the method 12 of remotely monitoring the patient is discussed. The method 12 initially includes the steps of providing the plurality of input sources 14a-c, the controller 16, and the database 18 described above. These devices are communicatively coupled to each other as described above. The input sources 14a-c provide information relating to a patient's well-being by sensing or detecting the information via a sensor, or when the patient activates the source. The input sources 14a-c transmit a signal representative of the information to the controller 16. The processor 24 interprets the information and retrieves analytical data, models, or statistics from the database 18 based on the information. The controller 16 and/or a processor 24 performs an algorithm to select an appropriate model for analyzing the information. The processor 24 performs an algorithm to analyze the information and data using the model to determine the state of the patient. The processor 24 generates results from the algorithm including a recommendation for patient care, treatment, or other action. The recommendation is transmitted over the network 20 to the external entity 22 to initiate the action or for further processing, or to the database 18 for storing and for providing improved future analysis. Results may also be displayed by the interface 32 (FIGS. 3-5). The patient, another user, or a caregiver can interact with and provide inputs into the system 10 via the interface 32 at any time to provide additional information, to communicate with the external entity 22, or to change settings that affect the algorithm. The method 12 may include the step of analyzing the results and the model for accuracy concurrent with the above algorithms or after generation of the results.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A system for remotely monitoring a patient, the system comprising:
a plurality of input sources operable to acquire information corresponding to a condition of a patient;
a database for storing analytical models and medical data; and
a controller operable to receive the signal from the input sources, perform an algorithm to select an analytical model retrieved from the database based on the information and the data, perform an algorithm on the information and the data with the model to determine a state of the patient, determine a recommendation as a result of the state, and transmit the recommendation to at least one external entity for providing assistance to the patient.

2. The system of claim 1, wherein the controller comprises a prediction control module for determining an accuracy of the model.

3. The system of claim 1, further comprising an interface for displaying a result to and receiving an input from a user.

4. The system of claim 1, further comprising a docking station for communicatively connecting to a computing device, wherein the computing device includes an interface for displaying a result and receiving an input from a user.

5. The system of claim 1, wherein the controller communicates with the external database and the external entity via a network.

6. The system of claim 1, wherein the input sources are operable to generate a signal representative of the information and transmit the signal to the controller.

7. The system of claim 1, wherein at least one of the input sources is activated by an input from the patient, and at least one of the input sources is operable to automatically sense the condition of the patient.

8. The system of claim 1, wherein at least one of the input sources is operable to continuously sense the condition.

9. The system of claim 1, wherein the external entity is configured to communicate with additional external entities to carry out the recommendation.

10. The system of claim 1, wherein the controller is communicatively coupled to a plurality of external entities, which share health information of the patient between each other.

11. The system of claim 1, wherein the database creates new data conclusions and relationships as a result of the algorithm.

12. The system of claim 1, wherein the controller further comprises the database.

13. The system of claim 1, wherein the controller further comprises a transceiver for communicating with the input source, the database, and/or the external entity.

14. A system for remotely monitoring a patient, the system comprising:
a plurality of input sources operable to acquire information corresponding to a condition of a patient, wherein at least one of the input sources is activated by an input from the patient, and at least one of the input sources is operable to automatically sense the condition of the patient, wherein at least one of the input sources is operable to continuously sense the condition;
a database for storing analytical models and medical data; and
a controller configurable to be communicatively coupled to the plurality of input sources, the external database, and the external entity, the controller comprising:
a processor operable to receive the signal from the input sources, perform an algorithm to select an analytical model from the database based on the information and the data, perform an algorithm on the information and the data with the model to formulate a health prediction and determine a state of the patient, determine a recommendation as a result of the health prediction and the state, and transmit the recommendation to at least one external entity for providing assistance to the patient, the processor including a prediction control module for determining an accuracy of the model;
a docking station for communicatively connecting to a computing device having a graphical interface, the computing device being operable to receive an input from the patient; and
a transceiver being operable to communicate with the plurality of input sources.

15. A method for remotely monitoring a patient, the method comprising the steps of:
providing a plurality of input sources for acquiring information related to a condition of the patient;
providing a controller communicatively coupled to the plurality of input sources, the controller being operable to receive a signal representative of the information;
providing an external database for storing analytical models and medical data;
receiving the signal from one of the plurality of input sources;
retrieving data from and selecting an analytical model from the database based on the information;
performing an algorithm on the information and the data with the analytical model;
determining a state of the patient using the information and the analytical model;
formulating a health prediction using the information and the analytical model;
determining a recommendation as a result of the state and the health prediction; and
transmitting the recommendation to an external entity for providing assistance to the patient.

16. The method of claim 15, further comprising the step of determining an accuracy of the model.

17. The method of claim 15, further comprising the step of activating the input source.

18. The method of claim 15, further comprising the step of creating a new data conclusion and/or relationship as a result the algorithm and storing it in the database for future analysis.

19. The method of claim 15, further comprising the step of displaying a result to a user via an interface, wherein the result is a graphical representation of health related data of the patient.

20. The method of claim 19, further comprising the step of receiving an input from the user via the interface.
